(19) United States
(12) Patent Application Publication
(10) Pub. No.: US 2024/0372624 A1
(43) Pub. Date: Nov. 7, 2024

(54) COMMUNICATION CONTROL DEVICE, COMMUNICATION DEVICE, COMMUNICATION CONTROL METHOD, AND RECORDING MEDIUM

(71) Applicant: NEC CORPORATION, Minato-ku, Tokyo (JP)

(72) Inventors: Koya TAKATA, Tokyo (JP); Hisashi MIZUMOTO, Tokyo (JP); fujo OKUMURA, Kanagawa (JP)

(73) Assignee: NEC CORPORATION, Minato-ku, Tokyo (JP)

(21) Appl. No.: 18/689,103

(22) PCT Filed: Sep. 21, 2021
(86) PCT No.: PCT/JP2021/034513

§ 371 Date: Mar. 5, 2024

(51) Int. Cl. H04B 10/508; H04B 10/11; H04B 10/69

(52) U.S. Cl. CPC H04B 10/508; H04B 10/11; H04B 10/691

(57) ABSTRACT

A communication control device that causes a transmitting device to transmit a scanning signal of a pulse pattern different between a first period and a second period, specify a direction of transmission of the scanning signal transmitted from a communication target according to a reception interval between the pulse pattern of the scanning signal transmitted from the communication target in the first period and the pulse pattern of the scanning signal transmitted from the communication target in the second period in response to reception of the scanning signal transmitted from the communication target by a receiving device, and transmit a notification signal of the pulse pattern relevant to the specified direction of transmission of the scanning signal to a transmitting device toward the communication target.

### TECHNICAL FIELD

The present disclosure relates to a communication control device and the like used for optical space communication using an optical signal propagating in a space.

### BACKGROUND ART

In optical space communication, optical signals (hereinafter, also referred to as a spatial optical signal) propagating in space are transmitted and received without using a medium such as an optical fiber. In general optical space communication, at a stage of searching for a communication target, communication is not established between a transmission side and a reception side of a spatial optical signal. Therefore, in general spatial optical communication, communication cannot be established unless the reception side detects that the spatial optical signal transmitted from the transmission side is received by the reception side.

PTL 1 discloses an optical space transmission system that transmits an optical signal by transmitting signal light from an optical transmitting device to an optical receiving device via a free space. The system of PTL 1 scans the transmission optical axis of the optical axis detection light at least twice at different speeds or in different directions within the transmission range. The system of PTL 1 detects a time difference between two light receiving timings from a change in received light power in a light receiving unit. The system of PTL 1 specifies the direction of the light receiving unit as viewed from the light emitting unit based on the time difference.

### CITATION LIST

### Patent Literature

PTL 1: JP 2007-053472 A

### SUMMARY OF INVENTION

### Technical Problem

According to the method of PTL 1, since the influence of the time delay due to the signal processing time or the like can be eliminated, the optical axis adjustment can be performed with high accuracy at high speed. In the method of PTL 1, the length of the pulse signal is changed and the pulse pattern is changed by changing the scanning times of the first and second scans performed twice. In the method of PTL 1, it is necessary to synchronize the operation with the communication target when scanning the communication target.

An object of the present disclosure is to provide a communication control device or the like capable of searching for a communication target without synchronizing operation with the communication target.

### Solution to Problem

A communication control device according to one aspect of the present disclosure is a communication control device that controls a communication device including a transmitting device that transmits a spatial optical signal and a receiving device that receives the spatial optical signal transmitted from a communication target, wherein the communication control device is configured to cause the transmitting device to transmit a scanning signal of a pulse pattern different between a first period in which the scanning signal is emitted in a forward direction and a second period in which the scanning signal is emitted in a direction opposite to the forward direction in a scan mode in which the scanning signal for searching for a communication target is transmitted, specify a direction of transmission of the scanning signal transmitted from the communication target according to a reception interval between the pulse pattern of the scanning signal transmitted from the communication target in the first period and the pulse pattern of the scanning signal transmitted from the communication target in the second period in response to reception of the scanning signal transmitted from the communication target by the receiving device, and transmit a notification signal of the pulse pattern relevant to the specified direction of transmission of the scanning signal to the transmitting device toward the communication target.

A communication control method according to one aspect of the present disclosure is a communication control method for controlling a transmitting device that transmits a spatial optical signal and a receiving device that receives the spatial optical signal transmitted from a communication target, the communication control method causing a computer to execute causing the transmitting device to transmit a scanning signal having a pulse pattern different between a first period in which the scanning signal is emitted in a forward direction and a second period in which the scanning signal is emitted in a direction opposite to the forward direction in a scan mode in which the scanning signal for searching for the communication target is transmitted, causing the receiving device to receive the scanning signal transmitted from the communication target, acquiring a signal relevant to the scanning signal received by the receiving device, specifying a direction of transmission of the scanning signal by the communication target according to a reception interval between the pulse pattern of the scanning signal transmitted in the first period and the pulse pattern of the scanning signal transmitted in the second period, and causing the transmitting device to transmit a notification signal of the pulse pattern relevant to the direction of transmission of the specified scanning signal toward the communication target.

A program according to one aspect of the present disclosure is a program for controlling a transmitting device that transmits a spatial optical signal and a receiving device that receives the spatial optical signal transmitted from a communication target, the program causing a computer to execute causing the transmitting device to transmit a scanning signal having a pulse pattern different between a first period in which the scanning signal is emitted in a forward direction and a second period in which the scanning signal is emitted in a direction opposite to the forward direction in a scan mode in which the scanning signal for searching for the communication target is transmitted, causing the receiving device to receive the scanning signal transmitted from the communication target, acquiring a signal relevant to the scanning signal received by the receiving device, specifying a direction of transmission of the scanning signal by the communication target according to a reception interval between the pulse pattern of the scanning signal transmitted in the first period and the pulse pattern of the scanning signal transmitted in the second period, and causing the transmitting device to transmit a notification signal of the pulse pattern relevant to the direction of transmission of the specified scanning signal toward the communication target.

### Advantageous Effects of Invention

According to the present disclosure, it is possible to provide a communication control device or the like capable of searching for a communication target without synchronizing operation with the communication target.

### BRIEF DESCRIPTION OF DRAWINGS

FIG. 1 is a block diagram illustrating an example of a configuration of a communication device according to a first example embodiment.

FIG. 2 is a conceptual diagram for explaining an example of a scan area set in the communication device according to the first example embodiment.

FIG. 3 is a conceptual diagram illustrating an example of transmission of a spatial optical signal by the communication device according to the first example embodiment.

FIG. 4 is a conceptual diagram for explaining a scanning example of a scanning signal by the communication device according to the first example embodiment.

FIG. 5 is a conceptual diagram for explaining a reception example of a scanning signal transmitted from the communication device according to the first example embodiment.

FIG. 6 is a table summarizing patterns of spatial optical signals transmitted from the communication device according to the first example embodiment.

FIG. 7 is a conceptual diagram for explaining an example of a notification pattern according to a direction of transmission of a scanning signal transmitted from the communication device according to the first example embodiment.

FIG. 8 is a conceptual diagram for explaining an example of a notification pattern according to a direction of transmission of a scanning signal transmitted from the communication device according to the first example embodiment.

FIG. 9 is a conceptual diagram for explaining another example of a notification pattern according to a direction of transmission of a scanning signal transmitted from the communication device according to the first example embodiment.

FIG. 10 is a conceptual diagram for explaining another example of the notification pattern according to the direction of transmission of the scanning signal transmitted from the communication device according to the first example embodiment.

FIG. 11 is a conceptual diagram for explaining still another example of the notification pattern according to the direction of transmission of the scanning signal transmitted from the communication device according to the first example embodiment.

FIG. 12 is a conceptual diagram for explaining still another example of the notification pattern according to the direction of transmission of the scanning signal transmitted from the communication device according to the first example embodiment.

FIG. 13 is a conceptual diagram illustrating an example of a configuration of a transmitting device included in the communication device according to the first example embodiment.

FIG. 14 is a conceptual diagram illustrating an example of a pattern set in a modulation part of a spatial light modulator of a transmitting device included in the communication device according to the first example embodiment.

FIG. 15 is a conceptual diagram illustrating an example of a configuration of a receiving device included in the communication device according to the first example embodiment.

FIG. 16 is a conceptual diagram illustrating an example of a configuration of a communication control device included in the communication device according to the first example embodiment.

FIG. 17 is a conceptual diagram for explaining a transmission example of a scanning signal in a first modification according to the first example embodiment.

FIG. 18 is a conceptual diagram for explaining a transmission example of a scanning signal in a second modification according to the first example embodiment.

FIG. 19 is a conceptual diagram for explaining a reception example of a scanning signal in a third modification according to the first example embodiment.

FIG. 20 is a table summarizing patterns of spatial optical signals transmitted in the third modification according to the first example embodiment.

FIG. 21 is a conceptual diagram for explaining a scanning example of a scanning signal in a fourth modification according to the first example embodiment.

FIG. 22 is a block diagram illustrating an example of a configuration of a communication control device according to a second example embodiment.

FIG. 23 is a block diagram illustrating an example of a hardware configuration that executes control and processing according to each example embodiment.

### EXAMPLE EMBODIMENT

Hereinafter, example embodiments of the present invention will be described with reference to the drawings. However, the example embodiments described below may be technically limited for carrying out the present invention, but the scope of the invention is not limited to the following. In all the drawings used in the following description of the example embodiment, the same reference numerals are given to the same parts unless there is a particular reason. In the following example embodiments, repeated description of similar configurations and operations may be omitted.

In all the drawings used for description of the following example embodiments, the directions of the arrows in the drawings are merely examples, and do not limit the directions of light and signals. A line indicating a trajectory of light in the drawings is conceptual, and does not accurately indicate an actual traveling direction or state of light. For example, in the drawings, a change in a traveling direction or a state of light due to refraction, diffraction, reflection, diffusion, or the like at an interface between air and a substance may be omitted, or a light flux may be expressed by one line.

### First Example Embodiment

First, a communication device according to a first example embodiment will be described with reference to the drawings. The communication device of the present example embodiment is used for optical space communication in which optical signals (hereinafter, also referred to as a spatial optical signal) propagating in a space are transmitted and received without using a medium such as an optical fiber. Hereinafter, the spatial optical signal to be transmitted may be referred to as a first spatial optical signal, and the spatial optical signal to be received may be referred to as a second spatial optical signal.

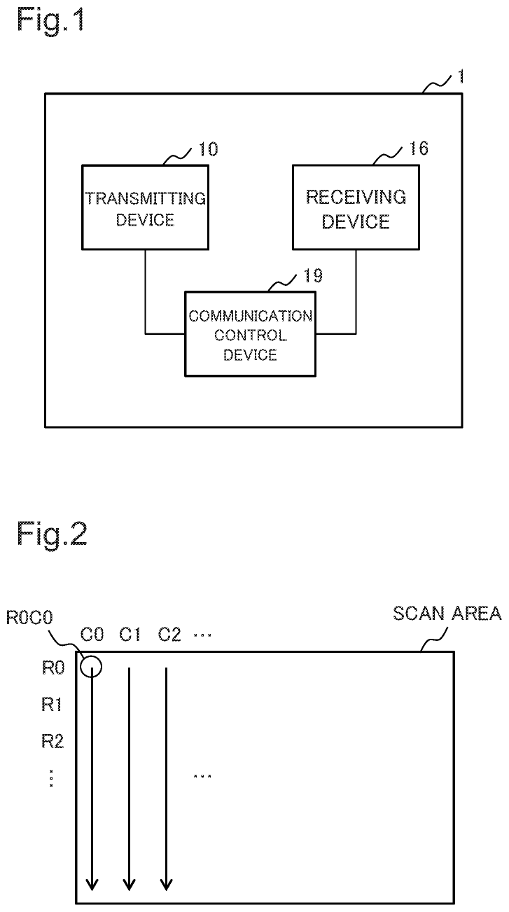

FIG. 1 is a block diagram illustrating an example of a configuration of a communication device 1 according to the present example embodiment. The communication device 1 of the present example embodiment includes a transmitting device 10, a receiving device 16, and a communication control device 19. Before describing the configuration of each of the transmitting device 10, the receiving device 16, and the communication control device 19, a method of scanning a communication target in the present example embodiment will be described. Details of the configurations of the transmitting device 10, the receiving device 16, and the communication control device 19 will be described later.

### [Scanning Method]

In the present example embodiment, a scanning spatial optical signal (also referred to as a scanning signal) is transmitted from the communication device 1 (search side) that is searching for a communication target. The other communication device 1 (searched side) that has received the scanning signal returns a spatial optical signal (also referred to as a notification signal) notifying reception of the scanning signal to the communication device 1 (searched side) that is a transmission source of the scanning signal. The communication device 1 on the search side and the communication device 1 on the searched side have similar configurations. The communication device 1 (search side) that has received the notification signal transmits a spatial optical signal (also referred to as a notification completion signal) indicating that the position of the communication target has been specified to the communication device 1 (searched side) as the communication target. Through such a series of procedures, optical space communication between at least two communication devices 1 is established. By repeating transmission and reception of the scanning signal, the notification signal, and the notification completion signal between the communication devices 1, it is possible to specify each other's positions more accurately. In the present example embodiment, the communication devices 1 that establish communication do not have to scan each other. In the present example embodiment, when one of the communication devices 1 that establish communication starts scanning, communication between the communication devices 1 can be established. For example, the scan of the communication target is performed at the time of startup of the communication network including the plurality of communication devices 1 or at a predetermined time. The time point at which the communication target is scanned is not particularly limited.

FIG. 2 is a conceptual diagram for explaining a scan area of the communication device 1. In FIG. 2, C represents a column, and R represents a row. Position coordinates (also referred to as a scan address) of the target at the time of transmitting the spatial optical signal are set in the scan area. In the example of FIG. 2, a coordinate system (also referred to as a transmission coordinate system) having an origin (R0C0) at the upper left of the scan area is set. For example, the scan address in the second row and the third column is expressed as (R1C2). The number and interval of scan addresses set in the scan area are not particularly limited.

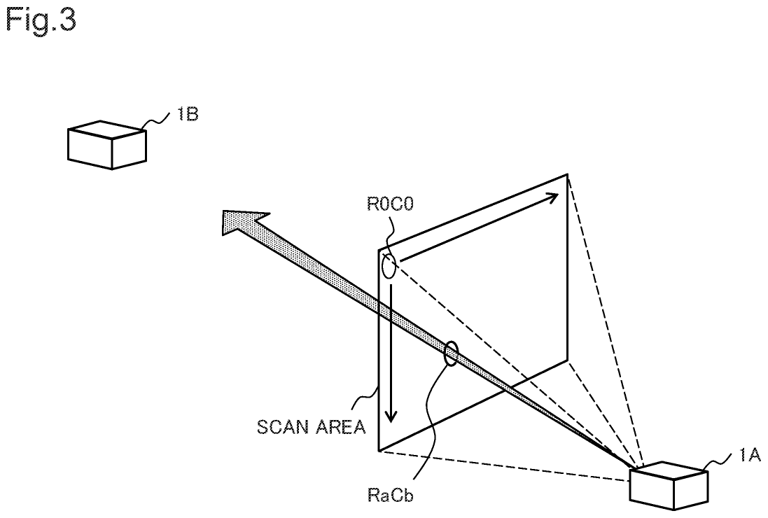

FIG. 3 is a conceptual diagram illustrating a state in which a spatial optical signal is transmitted from the communication device 1 toward the scan area set in the communication device 1. The communication device 1 transmits a spatial optical signal with a scan address set in a scan area of the communication device 1 as a target. The example of FIG. 3 illustrates a state in which the communication device 1 transmits the spatial optical signal toward the scan address (RaCb) of the scan area (a and b are natural numbers). Hereinafter, the communication device 1 on the search side is referred to as a communication device 1A, and the communication device 1 on the searched side is referred to as a communication device 1B. FIG. 3 illustrates an example in which the communication device 1A transmits a spatial optical signal. FIG. 3 illustrates a search target (communication device 1B) of the communication device 1A. Any of the communication devices 1 can execute processing as a search side (communication device 1A) and processing as a searched side (communication device 1B). For example, in a case where the searched side (communication device 1B) searches for the search side (communication device 1A), the communication device 1B that has been the searched side executes processing as the search side (communication device 1A). For the communication device 1A on the search side, the communication device 1B on the searched side corresponds to a communication target. On the other hand, for the communication device 1B on the searched side, the communication device 1A on the search side corresponds to the communication target.

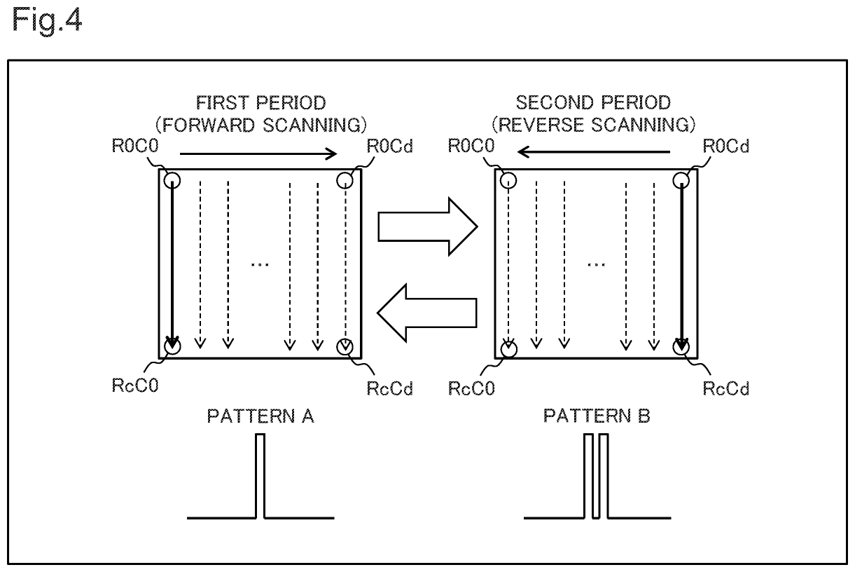

FIG. 4 is a conceptual diagram for explaining an example of scanning of a communication target (communication device 1B) by the communication device 1A. In a scanning stage of a communication target (communication device 1B), the communication device 1A sequentially transmits a spatial optical signal (scanning signal) toward a plurality of scan addresses set in a scan area of the communication device 1A.

The communication device 1A executes scanning for each column (also referred to as column scanning) from top to bottom with an upper left origin (R0C0) as a starting point. The transmitting device 10 executes column scanning (also referred to as forward scanning) from left to right. A period during which the forward scanning is performed is referred to as a first period. In the first period, the communication device 1A transmits a spatial optical signal (scanning signal) including a signal of pattern A (also referred to as a first scanning pattern). The pattern-A signal includes one pulse signal.

When the forward scanning is completed up to the lower right (RcCd), the communication device 1A executes column scanning from top to bottom with the upper right (R0Cd) as a starting point. The communication device 1A executes column scanning (also referred to as reverse scanning) from right to left. A period during which the reverse scanning is performed is referred to as a second period. In the second period, the communication device 1A transmits a spatial optical signal (scanning signal) including a signal of pattern B (also referred to as a second scanning pattern). The pattern-B signal includes two pulse signals.

The communication device 1A repeats forward scanning and reverse scanning until receiving a reply from the communication target (communication device 1B). A period of one forward scanning and one reverse scanning is referred to as a scanning period. The example of FIG. 4 is an example, and the scanning method of the communication target (communication device 1B) by the communication device 1A is not limited. FIG. 4 illustrates pattern A including one pulse signal and pattern B including two pulse signals. Pattern A and pattern B may be any pattern as long as they can be distinguished from each other. The communication device 1A and the communication device 1B that perform optical space communication with each other share patterns of scanning signals to be transmitted and received with each other. FIG. 4 illustrates an example in which column scanning is performed from top to bottom. The column scanning may be performed from bottom to top. FIG. 4 illustrates an example in which scanning is performed for each column. The scanning may be performed row by row. In FIG. 4, a column scanning from left to right is a forward scanning, and a column scanning from right to left is a reverse scanning. The column scanning from right to left may be referred to as forward scanning, and column scanning from left to right may be referred to as reverse scanning.

For example, in a case where more detailed scanning is performed, the spatial optical signal may be transmitted toward position coordinates in the middle of the scan address set in the scan area. For example, in a case where mutual communication is performed with a communication target (communication device 1B) for which communication has been established, a spatial optical signal including communication contents is transmitted toward a direction in which the communication target (communication device 1B) is located with reference to a scan address set in a scan area. In a case where mutual communication with a communication target (communication device 1B) for which communication has been established is performed, a spatial optical signal is transmitted with reference to a scan address.

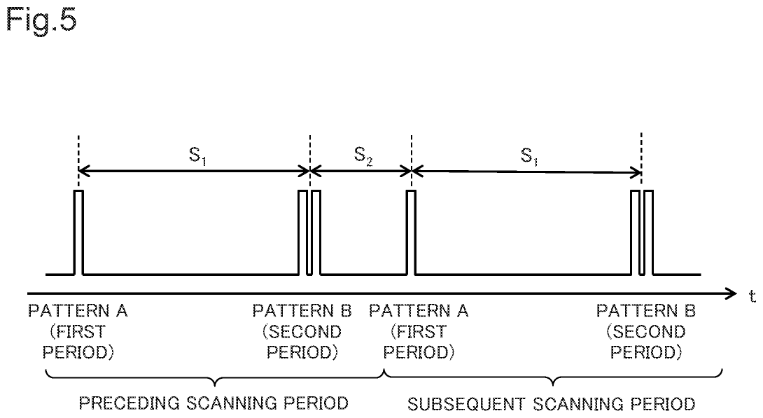

FIG. 5 is a conceptual diagram for explaining a reception example of a scanning signal by a communication target (communication device 1B). The communication device 1B that has received the scanning signal transmitted from another communication device 1 (communication device 1A) specifies the position of the communication target (communication device 1A) that is the transmission source of the scanning signal according to the reception pattern of the scanning signal. FIG. 5 illustrates two scanning periods. The first scanning period is a preceding scanning period. A second scanning period subsequent to the first scanning period is a subsequent scanning period.

In the preceding scanning period, an interval between the reception timing of the scanning signal transmitted in pattern A and the reception timing of the scanning signal transmitted in pattern B is S₁ (also referred to as a first interval). An interval between the reception timing of the scanning signal transmitted in pattern B in the preceding scanning period and the reception timing of the scanning signal transmitted in pattern A in the subsequent scanning period is S₂ (also referred to as a second interval). In the subsequent scanning period, an interval between the reception timing of the scanning signal transmitted in pattern A and the reception timing of the scanning signal transmitted in pattern B is S₁ (first interval). The communication device 1B specifies the position of the communication device 1A that is the transmission source of the scanning signal according to the ratio between the first interval S₁ and the second interval S₂.

When the communication device 1A that is the transmission source of the received scanning signal specifies the direction in which the scanning signal is transmitted, the communication device 1B generates a signal (also referred to as a notification pattern) including information for notifying the specified direction. The communication device 1B transmits a spatial optical signal (also referred to as a notification signal) including the generated signal to the communication device 1A that is a transmission source of the scanning signal. For example, when the arrival direction of the scanning signal is specified, the communication device 1B transmits the notification signal toward the arrival direction. When the arrival direction of the scanning signal is not specified, the communication device 1B may sequentially change the direction of transmission toward the scan area set in the communication device 1B and transmit the notification signal.

Upon receiving the notification signal from the communication target (communication device 1B), the communication device 1A generates a signal (completion notification pattern) including information for notifying that communication has been established. The communication device 1A transmits a spatial optical signal (also referred to as a completion notification signal) including the generated signal toward a communication target (communication device 1B) which is a transmission source of the notification signal. The position of the communication target (communication device 1B) that is the transmission source of the notification signal is specified in the scan area of the communication device 1A. Therefore, the communication device 1A transmits the completion notification signal in a direction in which the communication target (communication device 1B) is located. Through the above procedure, communication between the communication device 1A and the communication device 1B is established. A spatial optical signal (also referred to as a communication signal) including arbitrary communication contents is transmitted and received between the communication device 1A and the communication device 1B for which communication has been established.

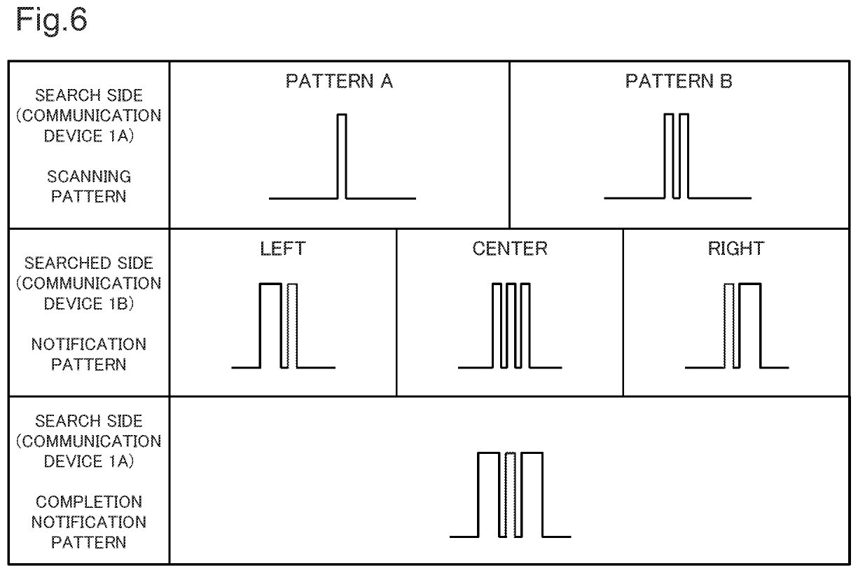

FIG. 6 is a table summarizing an example of a pattern of a spatial optical signal transmitted from the communication device 1. In the scanning mode, the communication device 1 on the search side (communication device 1A) transmits a scanning signal including a scanning pattern signal of pattern A or pattern B. When receiving the scanning signal, the communication target (communication device 1B) on the searched side specifies the direction of transmission of the light transmission source of the scanning signal according to the interval of the reception timing of the scanning pattern included in the scanning signal. The communication target (communication device 1B) on the searched side transmits a notification signal including a notification pattern related to the specified direction of transmission. When the direction of transmission of the specified scanning signal is left, a notification signal including a notification pattern in which a pulse having a long pulse width (also referred to as a long pulse) and a pulse having a short pulse width (also referred to as a short pulse) are continuous is transmitted. When the direction of transmission of the specified scanning signal is the center, a notification signal including a notification pattern in which three short pulses are continuous is transmitted. When the direction of transmission of the specified scanning signal is right, a notification signal including a notification pattern in which a short pulse and a long pulse are continuous is transmitted. When receiving the notification signal, the communication device 1 (communication device 1A) on the search side transmits a completion notification signal including a completion notification pattern in which a short pulse, a long pulse, and a long pulse are continuous to a communication target (communication device 1B) as a light transmission source of the notification signal. The pattern of FIG. 6 is an example, and does not limit the signal included in the spatial optical signal transmitted and received between the communication devices 1. The pattern of the spatial optical signal transmitted and received between the communication devices 1 may be set in advance between the communication devices 1.

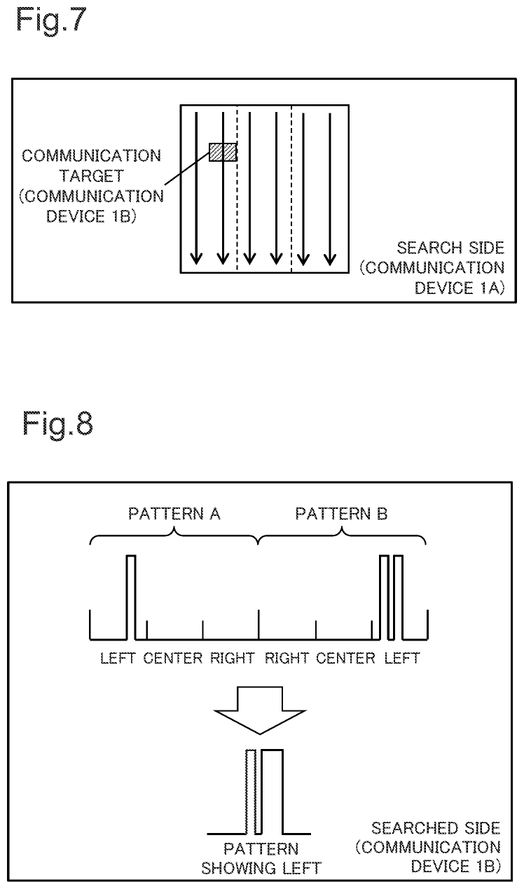

FIGS. 7 to 8 are conceptual diagrams for describing a reception example (FIG. 8) of the scanning signal in a case where the communication target (communication device 1B) is located in the left direction of the scan area set in the communication device 1 (communication device 1A) as the transmission source of the scanning signal (FIG. 7). As illustrated in FIG. 8, in a period in which the scanning signal transmitted in the first period is received, the communication target (communication device 1B) receives the scanning signal at an early timing of the period. On the other hand, in a period in which the scanning signal transmitted in the second period is received, the communication target (communication device 1B) receives the scanning signal at a later timing of the period. That is, the timing at which the scanning signal transmitted in the second period is received is later than the timing at which the scanning signal transmitted in the first period is received. Therefore, when the communication target is located in the left direction of the scan area set in the communication device 1 (communication device 1A) as the transmission source, the second interval S₂ has a larger value than the first interval S₁. That is, the ratio of the first interval S₁ to the second interval S₂ is smaller than 1. On the other hand, the ratio of the second interval S₂ to the first interval S₁ is larger than 1.

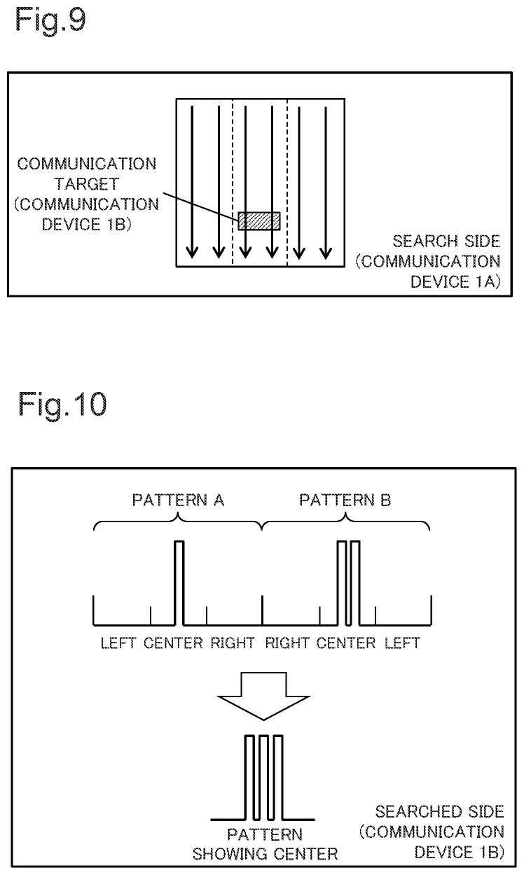

FIGS. 9 and 10 are conceptual diagrams for explaining a reception example (FIG. 10) of a scanning signal in a case where the communication target (communication device 1B) is located in a direction toward the center of the scan area set in the communication device 1 (communication device 1A) as a transmission source of the scanning signal (FIG. 9). As illustrated in FIG. 10, in a period in which the scanning signal transmitted in the first period is received, the communication target (communication device 1B) receives the scanning signal at a central timing of the period. On the other hand, also in the period in which the scanning signal transmitted in the second period is received, the communication target (communication device 1B) receives the scanning signal at the center timing of the period. That is, the timing at which the scanning signal transmitted in the first period is received and the timing at which the scanning signal transmitted in the second period is received are the same timing. Therefore, when the communication target (communication device 1B) is located in a direction toward the center of the scan area set in the communication device 1 (communication device 1A) as a transmission source, the first interval S₁ and the second interval S₂ have the same value. That is, the ratio of the first interval S₁ to the second interval S₂ is 1. Similarly, the ratio of the second interval S₂ to the first interval S₁ is 1.

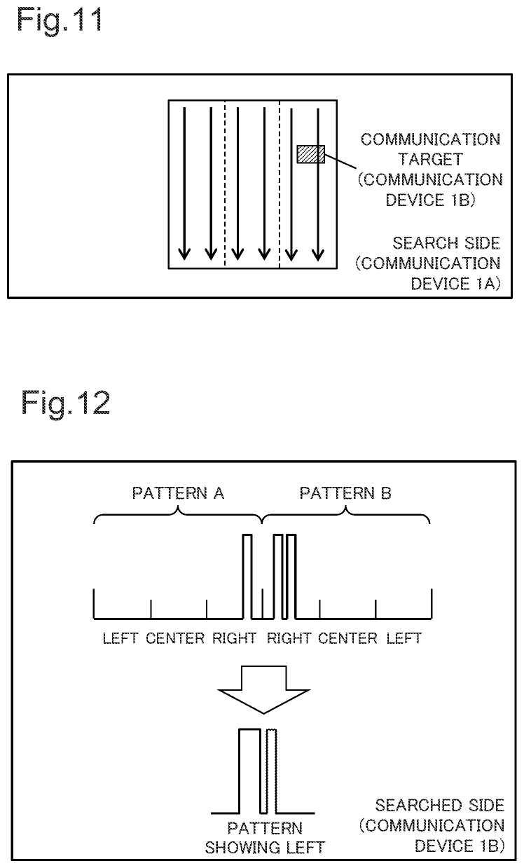

FIGS. 11 and 12 are conceptual diagrams for explaining a reception example (FIG. 12) of the scanning signal in a case where the communication target (communication device 1B) is located in the right direction of the scan area set in the communication device 1 (communication device 1A) as the transmission source of the scanning signal (FIG. 11). As illustrated in FIG. 12, in a period in which the scanning signal transmitted in the first period is received, the communication target (communication device 1B) receives the scanning signal at a later timing of the period. On the other hand, in a period in which the scanning signal transmitted in the second period is received, the communication target (communication device 1B) receives the scanning signal at an early timing of the period. That is, the timing at which the scanning signal transmitted in the second period is received is earlier than the timing at which the scanning signal transmitted in the first period is received. Therefore, when the communication target (communication device 1B) is located in the left direction of the scan area set in the communication device 1 (communication device 1A) as the transmission source, the second interval S₂ has a smaller value than the first interval S₁. That is, the ratio of the first interval S₁ to the second interval S₂ is larger than 1. On the other hand, the ratio of the second interval S₂ to the first interval S₁ is smaller than 1.

### [Transmitting Device]

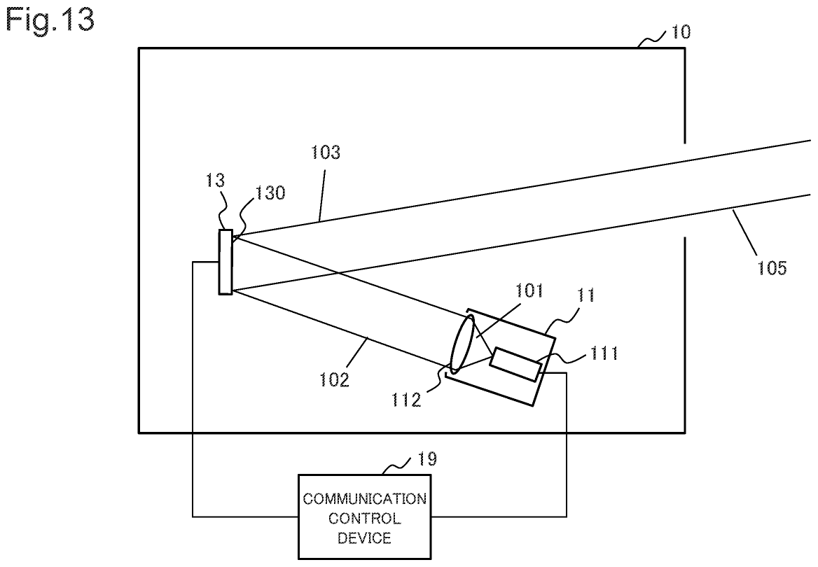

Next, a configuration of the transmitting device 10 will be described with reference to the drawings. FIG. 13 is a conceptual diagram illustrating an example of a configuration of the transmitting device 10. The transmitting device 10 includes a light source 11 and a spatial light modulator 13. The light source 11 includes an emitter 111 and a lens 112. FIG. 13 is a side view of an internal configuration of the transmitting device 10 as viewed from a lateral direction. FIG. 13 is conceptual, and does not accurately represent a positional relationship between components, a traveling direction of light, and the like.

The emitter 111 emits a laser beam 101 of a predetermined wavelength band toward the lens 112 under the control of the communication control device 19. The wavelength of the laser beam 101 emitted from the emitter 111 is not particularly limited, and may be selected according to the application. For example, the emitter 111 emits the laser beam 101 in visible or infrared wavelength bands. For example, in the case of near infrared rays of 800 to 900 nanometers (nm), the laser class can be given, and thus the sensitivity can be improved by about 1 digit as compared with other wavelength bands. For example, a high-power laser beam source can be used for infrared rays in a wavelength band of 1.55 micrometers (μm). As a laser light source in a wavelength band of 1.55 μm, an aluminum gallium arsenide phosphorus (AlGaAsP)-based laser light source, an indium gallium arsenide (InGaAs)-based laser light source, or the like can be used. The longer the wavelength of the laser beam 101 is, the larger the diffraction angle can be made and the higher the energy can be set.

The lens 112 emits the laser beam 101 emitted from the emitter 111 in accordance with the size of a modulation part 130 of the spatial light modulator 13. The laser beam 101 emitted from the emitter 111 is adjusted in the emission range by the lens 112 and emitted from the light source 11. The light 102 emitted from the light source 11 travels toward the modulation part 130 of the spatial light modulator 13.

The spatial light modulator 13 includes the modulation part 130. The modulation part 130 is irradiated with the light 102. The light 102 is modulated by the modulation part 130 and emitted as the modulation light 103. The modulation light 103 modulated by the modulation part 130 is projected as projection light 105. For example, a projection optical system that enlarges and projects the modulation light 103 may be disposed on an optical path of the modulation light 103. For example, the projection optical system has a structure in which a Fourier transform lens, an aperture, a projection lens, and the like are combined. Description of the projection optical system is omitted.

A pattern (also referred to as a phase image) relevant to the image displayed by the projection light 105 is set in the modulation part 130 under the control of the communication control device 19. When the spatial light modulator 13 is used, a high-order image is generated similarly to a diffraction grating because the diffraction phenomenon is used. For example, a mechanism for removing high-order light may be disposed on an optical path of the modulation light 103 or the projection light 105. The modulation light 103 includes 0th-order light. For example, a mechanism for removing 0th-order light may be disposed on an optical path of the modulation light 103 or the projection light 105.

The spatial light modulator 13 is achieved by a spatial light modulator using ferroelectric liquid crystal, homogeneous liquid crystal, vertical alignment liquid crystal, or the like. For example, the spatial light modulator 13 can be achieved by liquid crystal on silicon (LCOS). The spatial light modulator 13 may be achieved by a micro electro mechanical system (MEMS). In the spatial light modulator 13 of the phase modulation type, the energy can be concentrated on the portion of the image by operating to sequentially switch the portion on which the projection light 105 is projected. Therefore, in the case of using the spatial light modulator 13 of the phase modulation type, if the output of the light source 11 is the same, the image can be displayed brighter than other methods.

The modulation part 130 of the spatial light modulator 13 is divided into the plurality of regions (also referred to as tiling). For example, the modulation part 130 is divided into rectangular regions (also referred to as tiles) having a predetermined aspect ratio. Each of the plurality of tiles includes a plurality of pixels. A phase image is tiled to each of the plurality of tiles set in the modulation part 130. For example, a phase image generated in advance is set in each of the plurality of tiles. A phase image relevant to a projected image is set to each of the plurality of tiles.

When the modulation part 130 is irradiated with the light 102 in a state where the phase image is set in the plurality of tiles, the modulation light 103 is emitted to form an image relevant to the phase image of each tile. As the number of tiles set in the modulation part 130 increases, a clear image can be displayed. However, F when the number of pixels of each tile decreases, the resolution decreases. Therefore, the size and number of tiles set in the modulation part 130 are set according to the application.

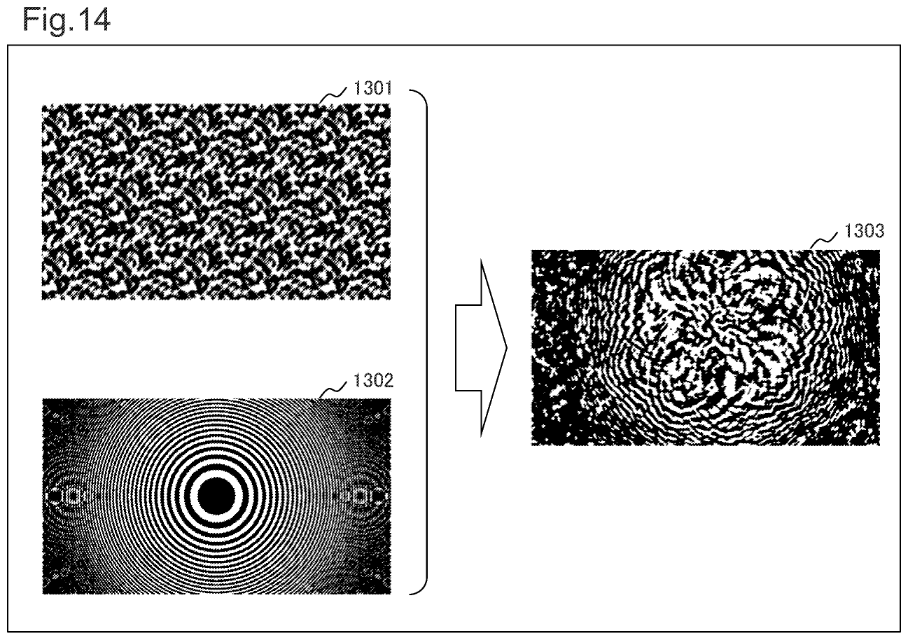

FIG. 14 is a conceptual diagram illustrating an example of a pattern set in the modulation part 130 of the spatial light modulator 13. A composite image 1303 is set in the modulation part 130. The composite image 1303 is a pattern obtained by combining a phase image 1301 for forming a desired image and a virtual lens image 1302 for condensing light for forming a desired image. The wavefront of light can be controlled by phase control, similar to diffraction. When the phase changes to a spherical shape, a spherical difference is generated in the wavefront, and a lens effect is generated. The virtual lens image 1302 changes the phase of the light 102 emitted to the modulation part 130 of the spatial light modulator 13 into a spherical shape, and generates a lens effect of condensing the light at a predetermined focal length.

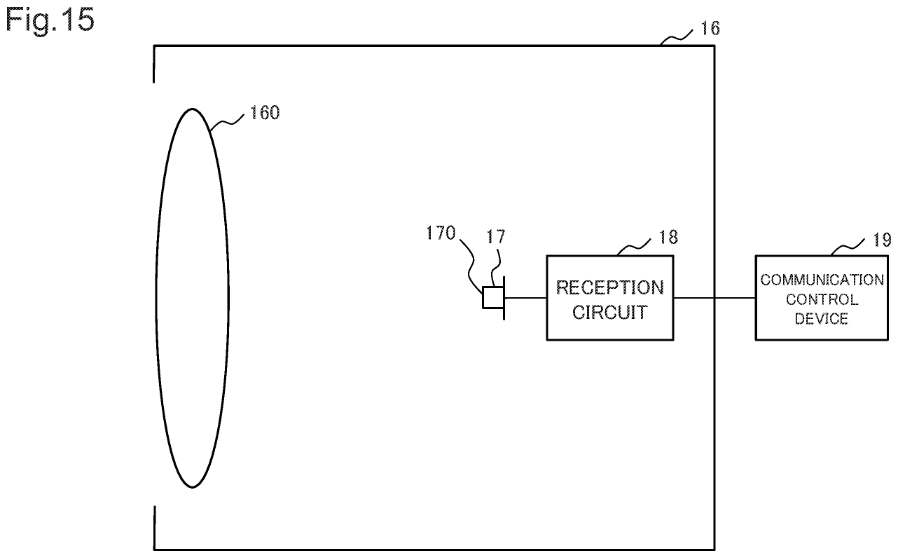

For example, a curved mirror (not illustrated) having a curved reflection surface may be disposed at the position of the condensing point of the virtual lens image 1302. The curved mirror is disposed with a curved reflection surface facing the modulation part 130 of the spatial light modulator 13. The curved mirror reflects the modulation light 103 modulated by the modulation part 130 of the spatial light modulator 13 on a curved reflection surface. The modulation light 103 reflected by the reflection surface of the curved mirror is projected as the projection light 105. The projection light 105 is enlarged and projected at an enlargement ratio relevant to the curvature of the reflection surface. For example, the image condensed by the virtual lens image 1302 is formed on the reflection surface of the curved mirror. For example, the composite image 1303 generated in advance may be stored in a storage unit (not illustrated). FIG. 15 is an example, and does not limit the patterns of the phase image 1301, the virtual lens image 1302, and the composite image 1303.

For example, a shield (not illustrated) may be disposed on an optical path of the modulation light 103 or the projection light 105. The shield is a frame that shields unnecessary light components included in the modulation light 103 and defines an outer edge of a display region of the projection light 105. The shield passes light that forms a desired image and blocks unwanted light components. For example, the shield is an aperture in which an opening is formed in a portion through which light forming a desired image passes. For example, the shield blocks a ghost image derived from high-order light included in the modulation light 103.

For example, a 0th-order light remover (not illustrated) may be disposed on the optical path of the modulation light 103 or the projection light 105. For example, the 0th-order light remover includes a light absorbing element supported by an element that supports the light absorbing element. The light absorbing element is fixed on the optical path of the 0th-order light included in the modulation light 103 or the projection light 105 by the support element. For example, the support element is made of a material such as glass or plastic through which the modulation light 103 or the projection light 105 passes. For example, a black body such as carbon is used for the light absorbing element. When the wavelength of the laser beam 101 to be used is fixed, the light absorbing element made of a material that selectively absorbs light having the wavelength of the laser beam 101 may be used.

### [Receiving Device]

Next, a configuration of the receiving device 16 will be described with reference to the drawings. FIG. 15 is a conceptual diagram for explaining an example of a configuration of the receiving device 16. The receiving device 16 includes a concentrator 160, a light receiving element 17, and a reception circuit 18. FIG. 15 is a plan view of the internal configuration of the receiving device 16 as viewed from above. The position of the reception circuit 18 is not particularly limited. The reception circuit 18 may be disposed inside the receiving device 16 or may be disposed outside the receiving device 16. The function of the reception circuit 18 may be included in the communication control device 19.

The concentrator 160 is an optical element that collects a spatial optical signal arriving from the outside. The spatial optical signal is incident on the incident surface of the concentrator 160. The optical signal collected by the concentrator 160 is collected toward a light receiving unit 170 of the light receiving element 17. For example, the concentrator 160 is a lens that collects an incident spatial optical signal. For example, the concentrator 160 is a light beam control element that guides the incident spatial optical signal toward the light receiving unit 170 of the light receiving element 17. For example, the concentrator 160 may have a configuration in which a lens or a light beam control element is combined. The configuration of the concentrator 160 is not particularly limited as long as the spatial optical signal can be condensed toward the region where the light receiving element 17 is disposed. For example, a mechanism that guides the optical signal condensed by the concentrator 160 toward the light receiving unit 170 of the light receiving element 17 may be added.

The light receiving element 17 is disposed at a subsequent stage of the concentrator 160. The light receiving element 17 is disposed in such a way that the light emitting surface of the concentrator 160 and the light receiving unit 170 face each other. The light receiving element 17 includes a light receiving unit 170 that receives the optical signal collected by the concentrator 160. The optical signal collected by the concentrator 160 is received by the light receiving unit 170 of the light receiving element 17. The light receiving element 17 converts the received optical signal into an electric signal (hereinafter, also referred to as a signal). The light receiving element 17 outputs the converted signal to the reception circuit 18.

The light receiving element 17 receives light in a wavelength region of the spatial optical signal to be received. For example, the light receiving element 17 has sensitivity to light in the visible region. For example, the light receiving element 17 has sensitivity to light in an infrared region. The light receiving element 17 has sensitivity to light having a wavelength in a 1.5 μm (micrometer) band, for example. The wavelength band of light with which the light receiving element 17 has sensitivity is not limited to the 1.5 μm band. The wavelength band of the light received by the light receiving element 17 can be set in accordance with the wavelength of the spatial optical signal to be received. The wavelength band of the light received by the light receiving element 17 may be set to, for example, a 0.8 μm band, a 1.55 μm band, or a 2.2 μm band. The wavelength band of the light received by the light receiving element 17 may be, for example, a 0.8 to 1 μm band. A shorter wavelength band is advantageous for optical space communication during rainfall because absorption by moisture in the atmosphere is small. If the light receiving element 17 is saturated with intense sunlight, the light receiving element cannot read the optical signal derived from the spatial optical signal. Therefore, a color filter that selectively passes the light of the wavelength band of the spatial optical signal may be installed at the preceding stage of the light receiving element 17.

For example, the light receiving element 17 can be achieved by an element such as a photodiode or a phototransistor. For example, the light receiving element 17 is achieved by an avalanche photodiode. The light receiving element 17 implemented by the avalanche photodiode can support high-speed communication. The light receiving element 17 may be achieved by an element other than a photodiode, a phototransistor, or an avalanche photodiode as long as an optical signal can be converted into an electric signal. In order to improve the communication speed, the light receiving unit of the light receiving element 17 may be as small as possible. For example, the light receiving unit of the light receiving element 17 has a square light receiving surface having a side of about 5 mm (mm). For example, the light receiving unit of the light receiving element 17 has a circular light receiving surface having a diameter of about 0.1 to 0.3 mm. The size and shape of the light receiving unit of the light receiving element 17 may be selected according to the wavelength band, the communication speed, and the like of the spatial optical signal.

For example, a filter (not illustrated) may be disposed in the preceding stage of the light receiving element 17. The filter is disposed in association with the light receiving unit 170 of the light receiving element 17. For example, the filter is disposed to overlap the light receiving unit 170 of the light receiving element 17. For example, the filter may be selected according to the polarization state of the spatial optical signal to be received. For example, when the spatial optical signal to be received is linearly polarized light, the filter includes a ½ wave plate. For example, when the spatial optical signal to be received is circularly polarized light, the filter includes a ¼ wave plate. The polarization state of the optical signal having passed through the filter is converted according to the polarization characteristic of the filter.

The reception circuit 18 acquires a signal output from the light receiving element 17. The reception circuit 18 amplifies the signal from the light receiving element 17. The reception circuit 18 decodes the amplified signal. The signal decoded by the reception circuit 18 is used for any purpose. The use of the signal decoded by the reception circuit 18 is not particularly limited.

### [Communication Control Device]

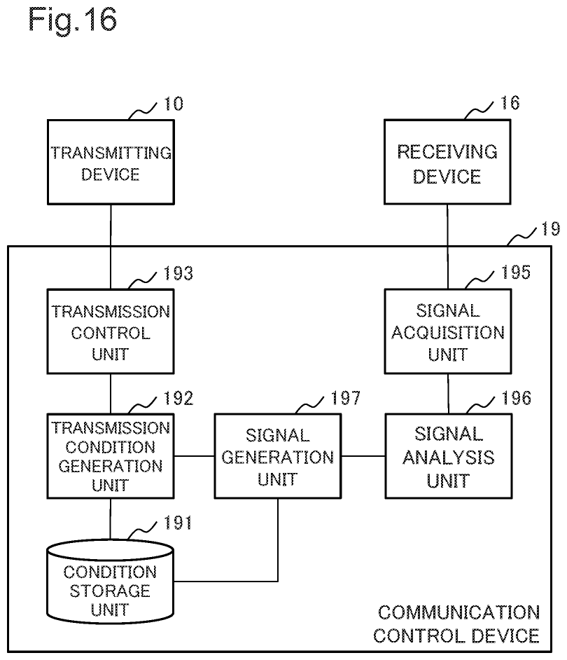

Next, a configuration of the communication control device 19 will be described with reference to the drawings. FIG. 16 is a block diagram for explaining an example of a configuration of the communication control device 19. The communication control device 19 includes a condition storage unit 191, a transmission condition generation unit 192, a transmission control unit 193, a signal acquisition unit 195, a signal analysis unit 196, and a signal generation unit 197. For example, the communication control device 19 is achieved by a microcomputer including a processor and a memory. For example, the communication control device 19 may be mounted on a server or a cloud connected to the transmitting device 10 and the receiving device 16 via a network.

The condition storage unit 191 stores a pattern (also referred to as a phase image) relevant to the projection light 105 transmitted by the transmitting device 10. The pattern stored in the condition storage unit 191 is set in the modulation part 130 of the spatial light modulator 13. The condition storage unit 191 stores projection conditions including a light source control condition for controlling the light source 11 of the transmitting device 10 and a modulator control condition for controlling the spatial light modulator 13 of the transmitting device 10. The light source control condition is a condition including a timing at which the laser beam 101 is emitted from the light source 11 of the transmitting device 10. The modulator control condition is a condition for setting a pattern in the modulation part 130 of the spatial light modulator 13. By coordinating the light source control condition and the modulator control condition, the projection light 105 relevant to the pattern set in the modulation part 130 of the spatial light modulator 13 is projected.

The condition storage unit 191 stores pulse patterns such as a scanning pattern, a notification pattern, and a completion notification pattern added to the spatial optical signal transmitted by the transmitting device 10. The pulse pattern is referred to by the signal generation unit 197.

The transmission condition generation unit 192 acquires a signal from the signal generation unit 197. The transmission condition generation unit 192 generates a light transmission condition for transmitting information included in the acquired signal based on the condition stored in the condition storage unit 191. For example, the transmission condition generation unit 192 selects a pattern (phase image) for transmitting the information included in the acquired signal based on the projection condition stored in the condition storage unit 191. For example, the transmission condition generation unit 192 generates a light transmission condition for setting a pattern (phase image) relevant to an image projected for transmitting information included in the acquired signal to the modulation part 130 of the spatial light modulator 13. For example, the transmission condition generation unit 192 generates the light transmission condition for setting the phase image relevant to the projected image in the modulation part 130 of the spatial light modulator 13 in accordance with the aspect ratio of the timing set in the modulation part 130 of the spatial light modulator 13.

The transmission condition generation unit 192 generates a transmission condition for transmitting the scanning signal, the notification signal, the completion notification signal, and the communication signal. The scanning signal is a signal for scanning a communication target. The notification signal is a signal for notifying that the scanning signal has been received. The completion notification signal is a signal for notifying that the notification signal has been received. The communication signal includes information to be transmitted to a communication target for which communication is established. For example, the transmission condition generation unit 192 sets the transmission condition for controlling the blinking of the projection light 105 according to the information added to the scanning signal, the notification signal, the completion notification signal, and the communication signal.

The transmission condition generation unit 192 generates a transmission condition for transmitting a scanning signal in the scanning mode. The scanning signal is a signal for searching for a communication target. For the notification signal and the completion notification signal, transmission conditions are generated according to the signal generated by the signal generation unit 197. When the communication with the communication target is established and the mode shifts to the communication mode, the transmission condition generation unit 192 generates a transmission condition for transmitting a communication signal according to the signal generated by the signal generation unit 197.

The transmission control unit 193 controls the light source 11 and the spatial light modulator 13 of the transmitting device 10 based on the transmission condition set by the transmission condition generation unit 192. The transmission control unit 193 sets a phase image relevant to the projected image in the modulation part 130 of the spatial light modulator 13 based on the transmission condition. The transmission control unit 193 causes the light source 11 to emit the light 102 in accordance with the timing at which the phase image is set in the modulation part 130. As a result, the projection light 105 relevant to a spatial optical signal for scanning and communication is transmitted.

The transmission control unit 193 drives the spatial light modulator 13 in such a way that a parameter that determines a difference between a phase of the light 102 irradiated to the modulation part 130 of the spatial light modulator 13 and a phase of the modulation light 103 reflected by the modulation part 130 changes. Such a parameter is, for example, a parameter related to optical characteristics such as a refractive index and an optical path length. For example, the transmission control unit 193 adjusts the optical characteristics of the modulation part 130 by changing the voltage applied to the modulation part 130 of the spatial light modulator 13. The phase distribution of the light 102 with which the modulation part 130 of the spatial light modulator 13 of a phase modulation type is irradiated is modulated according to the optical characteristics of the modulation part 130. The method of driving the spatial light modulator 13 by the transmission control unit 193 is determined according to the modulation scheme of the spatial light modulator 13.

The transmission control unit 193 drives the emitter 111 of the light source 11 in a state where the phase image relevant to the image displayed by the projection light 105 is set in the modulation part 130. As a result, the light 102 emitted from the light source 11 is irradiated to the modulation part 130 of the spatial light modulator 13 in accordance with the timing at which the phase image is set in the modulation part 130 of the spatial light modulator 13. The light 102 emitted to the modulation part 130 of the spatial light modulator 13 is modulated according to the phase image set in the modulation part 130 of the spatial light modulator 13. The modulation light 103 modulated by the modulation part 130 of the spatial light modulator 13 is projected as projection light 105.

The signal acquisition unit 195 acquires the signal decoded by the receiving device 16 from the receiving device 16. The signal acquisition unit 195 acquires the signal to which the signal processing has been applied by the receiving device 16 from the receiving device 16. The signal acquired by the signal acquisition unit 195 includes a scanned communication target or a response transmitted from a communication target in communication according to the spatial optical signal transmitted from the communication device 1.

The signal analysis unit 196 analyzes the signal acquired by the signal acquisition unit 195. The signal analysis unit 196 analyzes information included in a signal according to the type of signal. The type of signal includes a scanning signal, a notification signal, a completion notification signal, and a communication signal.

The signal analysis unit 196 acquires the scanning signal transmitted from the communication target. The scanning signal includes two types of scanning patterns. The signal analysis unit 196 specifies the direction of transmission (transmission coordinate system of the transmission source) of the scanning signal according to the interval between the two types of scanning patterns included in the scanning signal. The signal analysis unit 196 outputs, to the signal generation unit 197, an instruction to generate a notification signal to be transmitted to a communication target that is a transmission source of the acquired scanning signal.

The signal analysis unit 196 acquires the notification signal transmitted from the communication target. The notification signal includes a direction of transmission (transmission coordinate system of the own device) of the scanning signal received by the communication target of the transmission source of the notification signal. The signal analysis unit 196 outputs, to the signal generation unit 197, an instruction to generate a completion notification signal notifying reception of the notification signal in the direction of transmission of the scanning signal included in the notification signal (the transmission coordinate system of the subject device).

The signal analysis unit 196 acquires the completion notification signal transmitted from the communication target. Upon receiving the completion notification signal, the signal analysis unit 196 outputs, to the signal generation unit 197, an instruction to generate a communication signal to be transmitted to a communication target that is a transmission source of the completion notification signal. The content of the communication signal is not particularly limited.

The signal analysis unit 196 acquires a communication signal transmitted from a communication target. Upon receiving the communication signal, the signal analysis unit 196 outputs, to the signal generation unit 197, an instruction to generate a communication signal to be transmitted to a communication target that is a transmission source of the communication signal according to content of the communication signal. The signal analysis unit 196 outputs an instruction to generate a communication signal including a response to the communication signal to the signal generation unit 197 according to the content of the received communication signal.

The signal generation unit 197 generates a signal to be transmitted to a communication target. The signal generation unit 197 generates a scanning signal, a notification signal, a completion notification signal, and a communication signal. The signal generation unit 197 outputs the generated signal to the transmission condition generation unit 192. Each of the scanning signal, the notification signal, the completion notification signal, and the communication signal generated by the signal generation unit 197 is as described above.

When shifting to the scanning mode, the signal generation unit 197 generates a scanning signal. The scanning signal is a signal for searching for a communication target. The scanning signals are transmitted in different patterns in the forward scanning in which the scan area is scanned in the forward direction and the reverse scanning in which the scan area is scanned in the reverse direction to the forward direction. The signal generation unit 197 generates a scanning signal of pattern A (first scanning pattern) in the first period of the forward scanning. The signal generation unit 197 generates a scanning signal (second scanning pattern) of pattern B in the second period of the reverse scanning. The first scanning pattern and the second scanning pattern are predetermined patterns with respect to the communication target. The first scanning pattern and the second scanning pattern are different patterns. For example, the signal generation unit 197 generates a scanning signal. The signal generation unit 197 may be configured to generate a scanning signal in response to an instruction from the signal analysis unit 196.

The signal generation unit 197 generates a notification signal in response to an instruction from the signal analysis unit 196. The notification signal is a signal for notifying the communication target as a transmission source of the scanning signal that the scanning signal transmitted from the communication target has been received. The notification signal is transmitted in a pattern according to the direction of transmission of the scanning signal in the scan area of the transmission source. The pattern (notification pattern) of the notification signal is a pattern determined in advance with respect to the communication target.

For example, it is assumed that a scan area of a transmission source is divided into three regions of a left region, a center region, and a right region. In a case where the direction of transmission of the scanning signal in the scan area of the transmission source is a left region, the signal generation unit 197 generates a notification signal including a pattern indicating that the direction of transmission of the received scanning signal is left. In a case where the direction of transmission of the scanning signal in the scan area of the transmission source is a center region, the signal generation unit 197 generates a notification signal including a pattern indicating that the direction of transmission of the received scanning signal is center. In a case where the direction of transmission of the scanning signal in the scan area of the transmission source is a right region, the signal generation unit 197 generates a notification signal including a pattern indicating that the direction of transmission of the received scanning signal is right.

The signal generation unit 197 generates a completion notification signal in response to an instruction from the signal analysis unit 196. The completion notification signal is a signal for notifying the communication target that is the transmission source of the notification signal that the notification signal transmitted from the communication target has been received. The completion notification signal is a pattern determined in advance with the communication target.

The signal generation unit 197 generates a communication signal in response to an instruction from the signal analysis unit 196. The communication signal is a signal transmitted and received to and from a communication target for which communication is established. The communication signal includes information to be transmitted toward the communication target. The information added to the communication signal may be predetermined content or content relevant to information included in the communication signal from the communication target. For example, in a case where a communication signal having contents relevant to information included in a communication signal from a communication target is generated, the information included in the communication signal transmitted from the communication target is displayed on a display device (not illustrated). For example, the operator who has confirmed the information displayed on the display device inputs a response to the displayed information to the communication control device 19 (signal generation unit 197) via an input device (not illustrated). For example, the signal generation unit 197 generates a communication signal including the input information. The content of the communication signal generated by the signal generation unit 197 is not particularly limited.

### Modification

Next, modifications according to the present example embodiment will be described with some examples. Four modifications (first to fourth modifications) will be described below. The first modification is an example in which a plurality of dots are simultaneously transmitted in the scanning mode. The second modification is an example in which the position of the communication target is specified by two-stage scanning in the scanning mode. The third modification is an example of specifying a communication target positioned in a direction relevant to a boundary of a plurality of regions allocated to a scan area in the scanning mode. The fourth modification is an example in which the scanning direction in the scanning mode is the lateral direction.

### First Modification

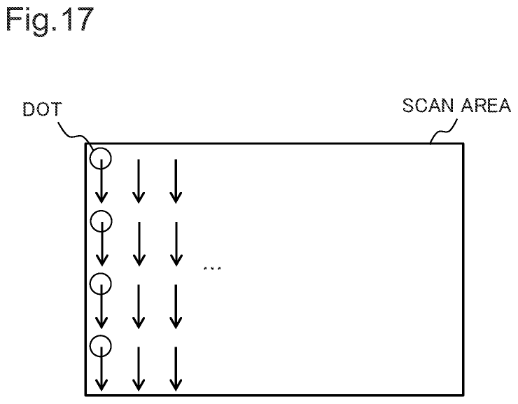

FIG. 17 is a conceptual diagram for explaining the first modification. In the present modification, in the scanning mode, a plurality of dots used for scanning of a communication target are simultaneously transmitted.

In the example of FIG. 17, four dots are simultaneously transmitted to the same column. Four dots simultaneously transmitted in the same column are simultaneously scanned from top to bottom at the same speed. As indicated by the arrows, the scanning distance of each dot is about ¼ as compared with the example of FIG. 2 and the like. In the case of the forward scanning, when the scanning is completed in one column, the process shifts to the scanning of the next right column. In the case of the reverse scanning, when the scanning is completed in one column, the process shifts to the scanning of the left adjacent column. According to the method of the present modification, by simultaneously transmitting the plurality of dots, the scanning distance in each column is shortened, and the overall scanning time is shortened. That is, according to the method of the present modification, the scanning time can be shortened.

### Second Modification

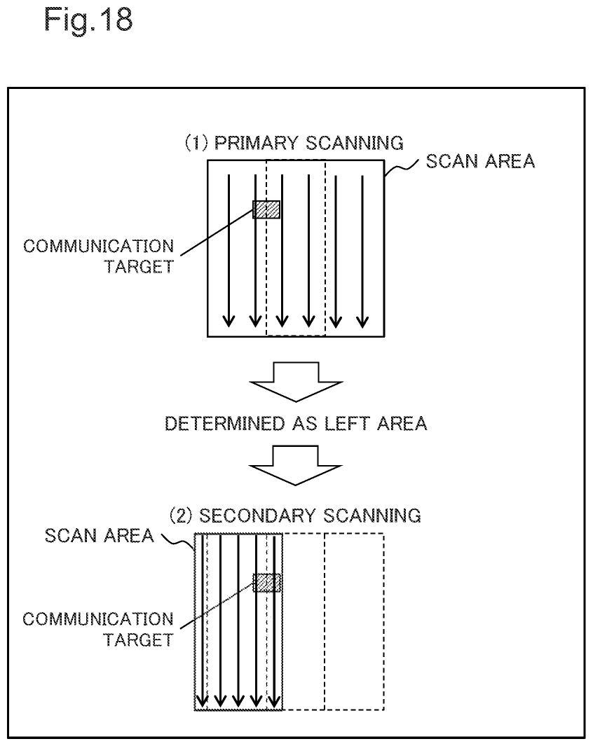

FIG. 18 is a conceptual diagram for explaining the second modification. In the present modification, in the scanning mode, the position of the communication target is specified by two-stage scanning. In the example of FIG. 18, the scan area is divided into three sub-areas.

In the example of FIG. 18, the scan area is divided into a left area, a center area, and a right area. In the example of FIG. 18, the communication target is located in the direction of the boundary between the left area and the center area. In the present modification, primary scanning and secondary scanning executed subsequent to the primary scanning are executed. In the primary scanning, the entire scan area is scanned. In the secondary scanning, a sub-area including the direction of the communication target specified in the primary scanning is scanned. In the secondary scanning, the interval between the columns to be scanned is narrower than in the primary scanning. In the present modification, when the communication target is located in the direction of the boundary between the adjacent sub-areas, the scanning range of any sub-area is expanded, and the secondary scanning is executed. In the case of FIG. 18, the scanning range of the left area is expanded. According to the present modification, the direction of the communication target specified in the primary scanning can be specified in more detail in the secondary scanning. According to the present modification, the position of the communication target in the direction relevant to the boundary between the adjacent sub-areas can be specified in more detail.

### Third Modification

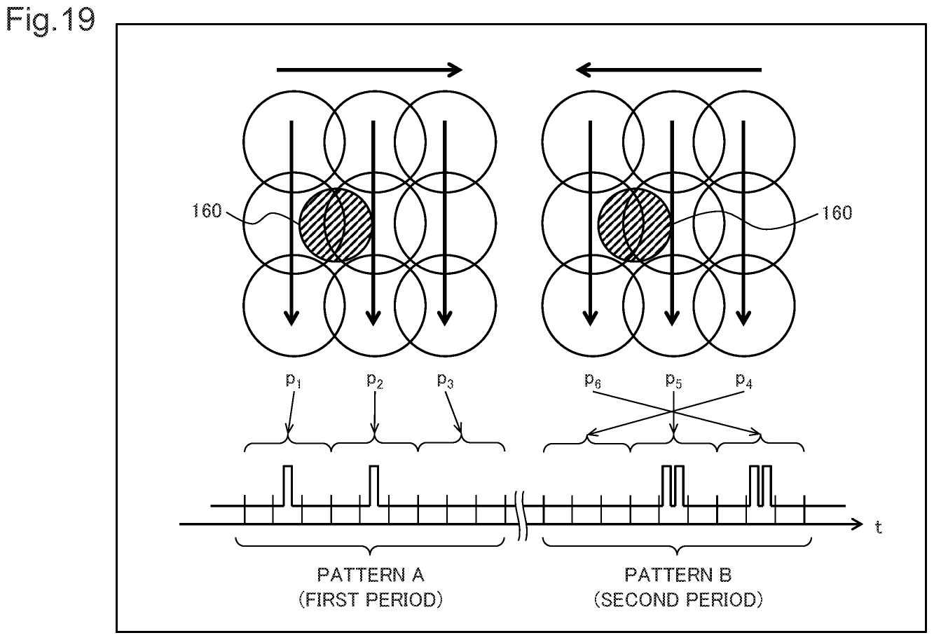

FIG. 19 is a conceptual diagram for explaining the third modification. In the present modification, in the scanning mode, a communication target located in a direction relevant to a boundary of a plurality of regions allocated to a scan area is specified.

FIG. 19 illustrates a relationship between the direction (upper side) of the concentrator 160 of the communication device 1B (communication target) in the scan area of the communication device 1A (search side) of the transmission source and the timing (lower side) at which the scanning signal is received by the communication device 1B (communication target). In the example of FIG. 19, the forward scanning in the first period and the reverse scanning in the second period are executed. The scan area is divided into three sub-areas of a left area, a center area, and a right area. In order to simplify the description, it is assumed that scanning of one column is performed for three rows in each sub-area. Irradiation ranges of adjacent dots have portions overlapping each other. The reception period of the scanning signal transmitted in the forward scanning includes three periods associated with the scanning of each column (p₁, p₂, p₃). The reception period of the scanning signal transmitted in the reverse scanning includes three periods associated with the scanning of each column (p₄, p₅, p₆). Each period associated with scanning of each column includes a first timing (upper), a second timing (middle), and a third timing (lower).

In the first period, the scanning signal of the pattern A is received at the second timing (middle) of the periods p₁ and p₂, and the scanning signal is not received in the period p₃. In the second period, the scanning signal is not received in the period p₄, and the scanning signal of the pattern B is received at the second timing (middle) of the periods p₅ and p₆. When the pattern A is received in the period p₁ of the first period and the pattern B is received in the period p₆ of the second period, it is determined that the communication device 1B (searched side) is located in the direction of the left area of the scan area set in the communication device 1A (searched side). When the pattern A is received in the period p₂ of the first period and the pattern B is received in the period p₅ of the second period, it is determined that the communication device 1B (searched side) is located in the direction of the center area of the scan area set in the communication device 1A (searched side). That is, in the example of FIG. 19, the same communication device 1B (searched side) is located in the left area and the center area of the scan area of the communication device 1A (searched side). In such a case, the communication device 1B (searched side) that has received the scanning signal determines that the communication device 1B that is the searched side is located in a direction of a boundary between a left area and a center area of a scan area of the communication device 1A (searched side) that is a transmission source of the scanning signal. In the present modification, in a case where the communication device 1B is located at a boundary between adjacent sub-areas, the communication device 1B on the search target side transmits a notification signal including a pattern indicating at which boundary the communication device 1B is located to the communication device 1A (search side) as a transmission source of the scanning signal.

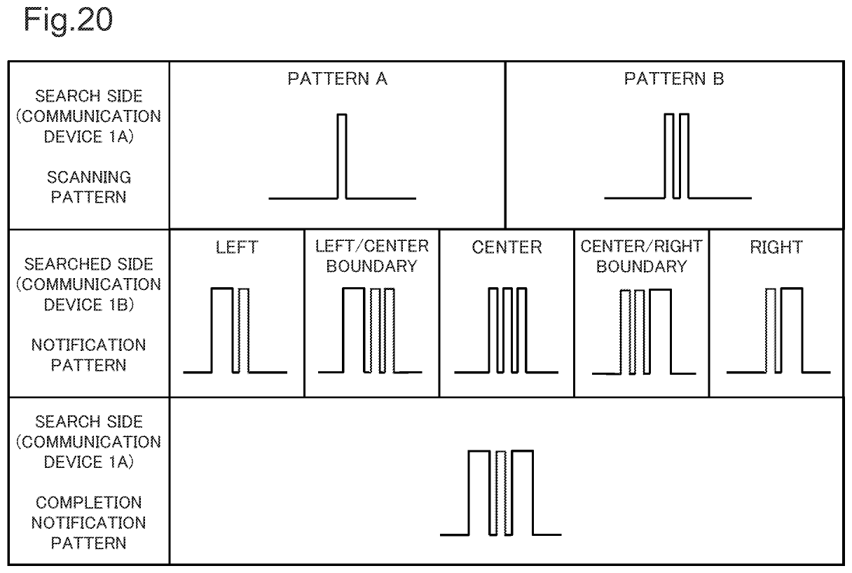

FIG. 20 is a table summarizing an example of a pattern of a spatial optical signal transmitted from the communication device 1 (search side) of the present modification. In the scanning mode, the communication device 1A (search side) transmits a scanning signal including a scanning pattern signal of pattern A or pattern B. When receiving the scanning signal, the communication device 1B (searched side) specifies the direction of transmission of the light transmission source of the scanning signal according to the interval of the reception timing of the scanning pattern included in the scanning signal. The communication device 1B (searched side) transmits a notification signal including a notification pattern regarding the specified direction of transmission. When the direction of transmission of the specified scanning signal is left, a notification signal including a notification pattern in which a pulse having a long pulse width (also referred to as a long pulse) and a pulse having a short pulse width (also referred to as a short pulse) are continuous is transmitted. When the direction of transmission of the specified scanning signal is a boundary between the left and the center (left/center boundary), a notification signal including a notification pattern in which a pulse having a long pulse width (also referred to as a long pulse) and two pulses having short pulse widths (also referred to as short pulses) are continuous is transmitted. When the direction of transmission of the specified scanning signal is the center, a notification signal including a notification pattern in which three short pulses are continuous is transmitted. When the direction of transmission of the specified scanning signal is a boundary between the center and the right (center/right boundary), a notification signal including a notification pattern in which two pulses with a long pulse width (also referred to as long pulses) and two pulses with a short pulse width (also referred to as short pulses) are continuous is transmitted. When the direction of transmission of the specified scanning signal is right, a notification signal including a notification pattern in which a short pulse and a long pulse are continuous is transmitted. When receiving the notification signal, the communication device 1A (search side) transmits a completion notification signal including a completion notification pattern in which a short pulse, a long pulse, and a long pulse are continuous to the communication device 1B (searched side) as a light transmission source of the notification signal. The pattern of FIG. 20 is an example, and does not limit a signal included in a spatial optical signal transmitted and received between the communication device 1A (search side) and the communication device 1B (searched side). The pattern of the spatial optical signal transmitted and received between the communication device 1A (search side) and the communication device 1B (searched side) may be set in advance between the communication device 1A (search side) and the communication device 1B (searched side).

According to the present modification, by subdividing the notification pattern according to the direction of transmission of the received scanning signal, it is possible to more accurately specify the direction of the communication device 1B (searched side), which is a communication target, in the scan area of the communication device 1A (searched side).

### Fourth Modification

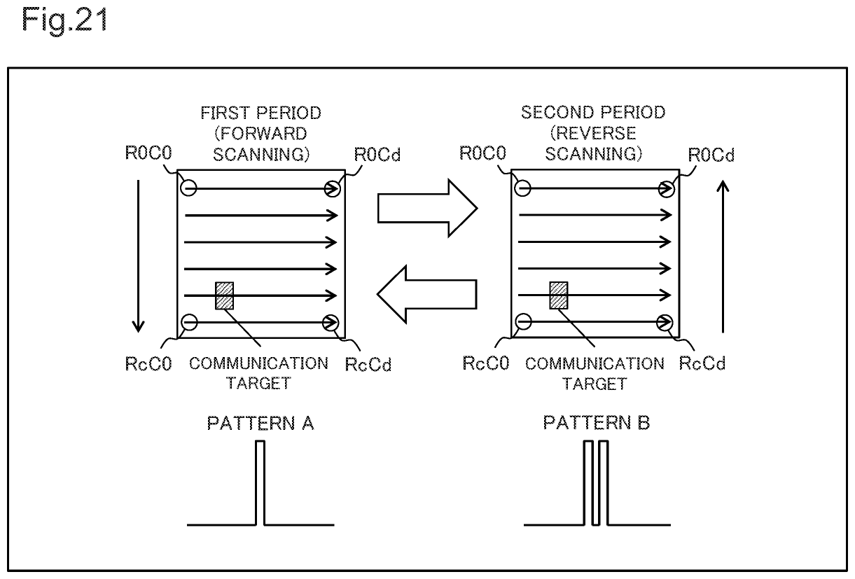

FIG. 21 is a conceptual diagram for explaining a fourth modification. In the present modification, the scanning direction in the scanning mode is the lateral direction.

The communication device 1A (search side) executes scanning for each row (also referred to as row scanning) from left to right with an upper left origin (R0C0) as a starting point. The communication device 1A (search side) executes row scanning (also referred to as forward scanning) from top to bottom. A period during which the forward scanning is performed is referred to as a first period. The communication device 1A (search side) transmits a spatial optical signal (scanning signal) including a signal of pattern A (also referred to as a first scanning pattern) in the first period. The pattern-A signal includes one pulse signal.

When the forward scanning is completed up to the lower right (RcCd), the communication device 1A (search side) executes row scanning from left to right with the lower left (RcC0) as a starting point. The communication device 1A (search side) executes row scanning (also referred to as reverse scanning) from right to left. A period during which the reverse scanning is performed is referred to as a second period. The communication device 1A (search side) transmits a spatial optical signal (scanning signal) including a signal of pattern B (also referred to as a second scanning pattern) in the second period. The pattern-B signal includes two pulse signals.

The communication device 1A (search side) repeats forward scanning and reverse scanning until receiving a reply from the communication device 1B (searched side) as a communication target. A period of one forward scanning and one reverse scanning is referred to as a scanning period. The example of FIG. 21 is an example, and does not limit a scanning method of the communication target (communication device 1B) by the communication device 1A (search side). FIG. 21 illustrates pattern A including one pulse signal and pattern B including two pulse signals. Pattern A and pattern B may be any pattern as long as they can be distinguished from each other. The communication device 1A (search side) and the communication device 1B (searched side) that perform optical space communication with each other share a pattern of a scanning signal to be transmitted and received with each other. FIG. 21 illustrates an example in which row scanning is performed from left to right. The row scanning may be performed from right to left. In FIG. 21, a row scanning from top to bottom is a forward scanning, and a row scanning from bottom to top is a reverse scanning. The row scanning from bottom to top may be a forward scanning, and a row scanning from top to bottom may be a reverse scanning.

As described above, the communication device according to the present example embodiment includes the transmitting device, the receiving device, and the communication control device. The transmitting device transmits the spatial optical signal under the control of the communication control device. The receiving device receives the spatial optical signal transmitted from the communication target, and outputs a reception signal included in the received spatial optical signal to the communication control device. The communication control device causes the transmitting device to transmit a scanning signal in a scan mode for transmitting a scanning signal for searching for a communication target. The communication control device causes the transmitting device to transmit scanning signals of different pulse patterns in a first period in which the scanning signal is emitted in a forward direction and a second period in which the scanning signal is emitted in a direction opposite to the forward direction. In response to reception of the scanning signal transmitted from the communication target by the receiving device, the communication control device specifies a direction of transmission of the scanning signal by the communication target. The communication control device specifies the direction of transmission of the scanning signal by the communication target according to the reception interval between the pulse pattern of the scanning signal transmitted from the communication target in the first period and the pulse pattern of the scanning signal transmitted from the communication target in the second period. The communication control device causes the transmitting device to transmit a notification signal of a pulse pattern relevant to the specified direction of transmission of the scanning signal toward the communication target.

In a scan mode for searching for a communication target, the communication device according to the present example embodiment transmits scanning signals of different pulse patterns in a first period for emitting in a forward direction and a second period for emitting a scanning signal in a direction opposite to the forward direction. The communication device of the present example embodiment specifies the direction of transmission of the scanning signal by the communication target according to the reception interval between the pulse pattern of the scanning signal transmitted from the communication target in the first period and the pulse pattern of the scanning signal transmitted from the communication target in the second period. Therefore, according to the communication control device of the present example embodiment, the communication target can be searched for without synchronizing the operation with the communication target.

In one aspect of the present example embodiment, the communication control device controls the transmitting device so as to repeat forward scanning and reverse scanning subsequent to the forward scanning for the scan area set in the communication device in the scan mode. In the forward scanning, the communication control device sequentially moves the one-dimensional scan in which the direction of transmission of the scanning signal is sequentially changed to the first direction toward the second direction orthogonal to the first direction. In the reverse scanning, the communication control device sequentially moves the one-dimensional scan in which the direction of transmission of the scanning signal is sequentially changed in the first direction in a direction opposite to the second direction. According to the present aspect, the communication target can be searched for by repeating the forward scanning and the reverse scanning.

In one aspect of the present example embodiment, the communication control device controls the transmitting device to transmit a scanning signal for displaying an image in which a plurality of dots are one-dimensionally arranged at regular intervals in one-dimensional scanning. According to the present aspect, the scanning time can be shortened by simultaneously transmitting a plurality of dots used for scanning of the communication target.

In one aspect of the present example embodiment, the communication control device specifies the position of the communication device in the scan area set as the communication target of the transmission source of the scanning signal according to the first interval and the second interval. The first interval is an interval between the reception timing of the pulse pattern of the scanning signal transmitted from the communication target in the first period and the reception timing of the pulse pattern of the scanning signal transmitted from the communication target in the second period next to the first period. The second interval is an interval between the reception timing of the pulse pattern of the scanning signal transmitted from the communication target in the second period and the reception timing of the pulse pattern of the scanning signal transmitted from the communication target in the first period next to the second period. According to the present aspect, the position of the communication device can be specified based on the reception timing of the pulse pattern of the scanning signal transmitted from the communication target.

In one aspect of the present example embodiment, in response to reception of the scanning signal, the communication control device specifies which sub-area assigned within the range of the scan area set as the communication target of the transmission source of the scanning signal the communication device is located in. The communication control device transmits a notification signal of a pulse pattern associated with the specified sub-area toward a communication target that is a transmission source of the scanning signal. According to the present aspect, it is possible to notify the communication target which sub-area assigned to the scan area set as the communication target the communication device is located in.

In one aspect of the present example embodiment, there is a case where the communication control device specifies that the communication device is located at a boundary of a plurality of sub-areas allocated within a range of a scan area set as a communication target of a transmission source of the scanning signal. When the communication device is specified to be located at the boundary of the plurality of sub-areas, the communication control device controls the transmitting device that transmits the notification signal of the pulse pattern associated with the boundary of the plurality of sub-areas toward the communication target of the transmission source of the scanning signal. According to the present aspect, it is possible to notify the communication target that the communication device is located in the direction of the boundary of the sub-area allocated to the scan area set as the communication target.

In one aspect of the present example embodiment, in a case where it is determined that the communication target is located at a boundary between adjacent sub-areas, the communication control device controls the transmitting device to widen a range of any sub-area where it is determined that the communication target is located and execute a secondary scan mode. According to the present aspect, in a case where it is determined that the communication target is located in the direction of the boundary between the adjacent sub-areas, the position of the communication target can be specified more accurately by executing the secondary scan mode.

In one aspect of the present example embodiment, in response to reception of the notification signal transmitted from the communication target, the communication control device causes the transmitting device to transmit a completion notification signal for notifying reception of the notification signal toward the communication target that is a transmission source of the notification signal. According to the present aspect, the communication between the communication device and the communication target can be established by notifying the communication target that the communication between the communication device and the communication target is enabled by the completion notification signal.

In one aspect of the present example embodiment, the communication control device causes the transmitting device to transmit a completion notification signal having a pulse pattern different from the pulse patterns of the scanning signal and the notification signal. According to the present aspect, by making the pulse patterns of the scanning signal, the notification signal, and the completion notification signal different from each other, it is possible to clarify that communication between the communication device and the communication target has been established.

### Second Example Embodiment

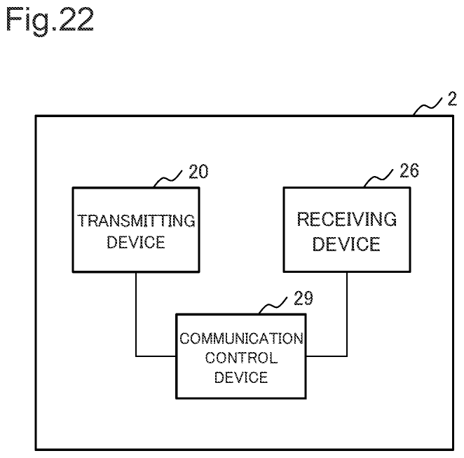

Next, a communication device according to a second example embodiment will be described with reference to the drawings. The communication device of the present example embodiment has a configuration in which the communication device of the first example embodiment is simplified. FIG. 22 is a block diagram illustrating an example of a configuration of a communication device 2 according to the present example embodiment. The communication device 2 includes a transmitting device 20, a receiving device 26, and a communication control device 29. The transmitting device 20 transmits the spatial optical signal. The receiving device 26 receives a spatial optical signal transmitted from a communication target.

The communication control device 29 causes the transmitting device 20 to transmit a scanning signal in a scan mode for transmitting a scanning signal for searching for a communication target. The communication control device 29 causes the transmitting device 20 to transmit scanning signals of different pulse patterns in a first period in which the scanning signal is emitted in the forward direction and a second period in which the scanning signal is emitted in a direction opposite to the forward direction. In response to reception of the scanning signal transmitted from the communication target by the receiving device 26, the communication control device 29 specifies a direction of transmission of the scanning signal by the communication target. The communication control device 29 specifies the direction of transmission of the scanning signal by the communication target according to the reception interval between the pulse pattern of the scanning signal transmitted from the communication target in the first period and the pulse pattern of the scanning signal transmitted from the communication target in the second period. The communication control device causes the transmitting device 20 to transmit a notification signal of a pulse pattern relevant to the specified direction of transmission of the scanning signal toward the communication target.

As described above, in the scan mode for searching for a communication target, the communication device according to the present example embodiment transmits scanning signals of different pulse patterns in the first period for emitting in the forward direction and the second period for emitting the scanning signal in the direction opposite to the forward direction. The communication device of the present example embodiment specifies the direction of transmission of the scanning signal by the communication target according to the reception interval between the pulse pattern of the scanning signal transmitted from the communication target in the first period and the pulse pattern of the scanning signal transmitted from the communication target in the second period. Therefore, according to the communication control device of the present example embodiment, the communication target can be searched for without synchronizing the operation with the communication target.

### (Hardware)

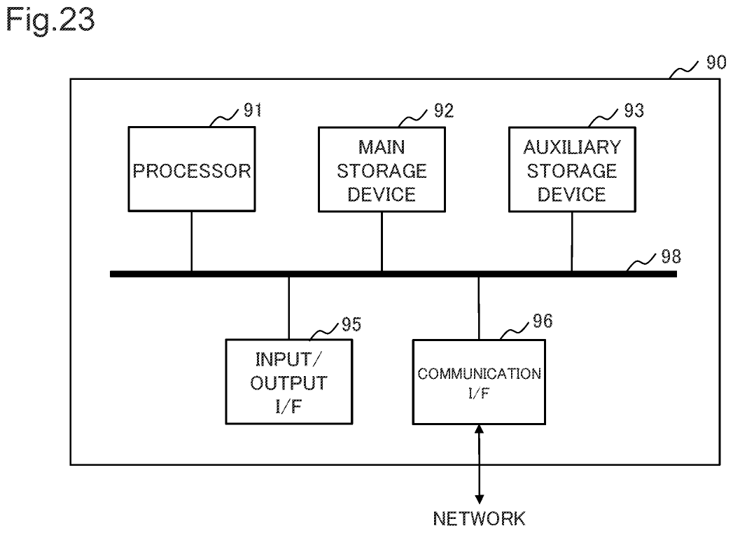

Here, a hardware configuration for executing processing of the control unit according to each example embodiment of the present disclosure will be described using an information processing device 90 of FIG. 23 as an example. The information processing device 90 in FIG. 23 is a configuration example for executing the control and processing of each example embodiment, and does not limit the scope of the present disclosure.

As illustrated in FIG. 23, the information processing device 90 includes a processor 91, a main storage device 92, an auxiliary storage device 93, an input/output interface 95, and a communication interface 96. In FIG. 23, the interface is abbreviated as an I/F. The processor 91, the main storage device 92, the auxiliary storage device 93, the input/output interface 95, and the communication interface 96 are data-communicably connected to each other via a bus 98. The processor 91, the main storage device 92, the auxiliary storage device 93, and the input/output interface 95 are connected to a network such as the Internet or an intranet via communication interface 96.

The processor 91 develops a program stored in the auxiliary storage device 93 or the like in the main storage device 92. The processor 91 executes the program developed in the main storage device 92. In the present example embodiment, a software program installed in the information processing device 90 may be used. The processor 91 executes processing or control according to each example embodiment.

The main storage device 92 has a region in which a program is developed. A program stored in the auxiliary storage device 93 or the like is developed in the main storage device 92 by the processor 91. The main storage device 92 is implemented by, for example, a volatile memory such as a dynamic random access memory (DRAM). A nonvolatile memory such as a magnetoresistive random access memory (MRAM) may be configured and added as the main storage device 92.

The auxiliary storage device 93 stores various data such as programs. The auxiliary storage device 93 is implemented by a local disk such as a hard disk or a flash memory. Various data may be stored in the main storage device 92, and the auxiliary storage device 93 may be omitted.

The input/output interface 95 is an interface for connecting the information processing device 90 and a peripheral device. The communication interface 96 is an interface for connecting to an external system or device through a network such as the Internet or an intranet based on a standard or a specification. The input/output interface 95 and the communication interface 96 may be shared as an interface connected to an external device.

An input device such as a keyboard, a mouse, or a touch panel may be connected to the information processing device 90 as necessary. These input devices are used to input information and settings. When the touch panel is used as an input device, the display screen of the display device may also serve as the interface of the input device. Data communication between the processor 91 and the input device may be mediated by the input/output interface 95.

The information processing device 90 may be provided with a display device for displaying information. In a case where a display device is provided, the information processing device 90 may include a display control device (not illustrated) for controlling display of the display device. The display device may be connected to the information processing device 90 via input/output interface 95.

The information processing device 90 may be provided with a drive device. The drive device mediates reading of data and a program from a recording medium, writing of a processing result of the information processing device 90 to the recording medium, and the like between the processor 91 and the recording medium (program recording medium). The drive device may be connected to the information processing device 90 via input/output interface 95.

The above is an example of the hardware configuration for enabling the control and processing according to each example embodiment of the present invention. The hardware configuration of FIG. 23 is an example of a hardware configuration for executing the control and processing of each example embodiment, and does not limit the scope of the present invention. A program for causing a computer to execute the control and processing according to each example embodiment is also included in the scope of the present invention. Further, a program recording medium in which the program according to each example embodiment is recorded is also included in the scope of the present invention. The recording medium can be achieved by, for example, an optical recording medium such as a compact disc (CD) or a digital versatile disc (DVD). The recording medium may be implemented by a semiconductor recording medium such as a universal serial bus (USB) memory or a secure digital (SD) card. The recording medium may be implemented by a magnetic recording medium such as a flexible disk, or another recording medium. When a program executed by the processor is recorded in a recording medium, the recording medium is associated to a program recording medium.

The components of each example embodiment may be arbitrarily combined. The components of each example embodiment may be implemented by software or may be implemented by a circuit.

Although the present invention has been described with reference to the example embodiments, the present invention is not limited to the above example embodiments. Various modifications that can be understood by those skilled in the art can be made to the configuration and details of the present invention within the scope of the present invention.

Some or all of the above example embodiments may be described as the following Supplementary Notes, but are not limited to the following.

### (Supplementary Note 1)

A communication control device that controls a communication device including a transmitting device that transmits a spatial optical signal and a receiving device that receives the spatial optical signal transmitted from a communication target, wherein the communication control device is configured to:
cause the transmitting device to transmit a scanning signal of a pulse pattern different between a first period in which the scanning signal is emitted in a forward direction and a second period in which the scanning signal is emitted in a direction opposite to the forward direction in a scan mode in which the scanning signal for searching for a communication target is transmitted;
specify a direction of transmission of the scanning signal transmitted from the communication target according to a reception interval between the pulse pattern of the scanning signal transmitted from the communication target in the first period and the pulse pattern of the scanning signal transmitted from the communication target in the second period in response to reception of the scanning signal transmitted from the communication target by the receiving device; and
transmit a notification signal of the pulse pattern relevant to the specified direction of transmission of the scanning signal to the transmitting device toward the communication target.

### (Supplementary Note 2)

The communication control device according to Supplementary Note 1, in which
the communication control device is configured to control the transmitting device in the scan mode in such a way to repeat:
a forward scanning of a scan area set in the communication device, the forward scanning being performed by sequentially moving one-dimensional scan in which the direction of transmission of the scanning signal is sequentially changed in a first direction toward a second direction orthogonal to the first direction; and
subsequent to the forward scanning, a reverse scanning of the scan area set in the communication device, the reverse scanning being performed by sequentially moving the one-dimensional scan in which the direction of transmission of the scanning signal is sequentially changed in the first direction toward a direction opposite to the second direction.

### (Supplementary Note 3)

The communication control device according to Supplementary Note 2, in which
the communication control device is configured to:
control the transmitting device to transmit the scanning signal for displaying an image in which a plurality of dots are one-dimensionally arranged at regular intervals in the one-dimensional scan.

### (Supplementary Note 4)

The communication control device according to Supplementary Note 3, in which
the communication control device is configured to specify a position of the communication device in the scan area set in the communication target of a transmission source of the scanning signal according to:
a first interval that is an interval between a reception timing of the pulse pattern of the scanning signal transmitted from the communication target in the first period and a reception timing of the pulse pattern of the scanning signal transmitted from the communication target in the second period next to the first period, and a second interval that is an interval between a reception timing of the pulse pattern of the scanning signal transmitted from the communication target in the second period and a reception timing of the pulse pattern of the scanning signal transmitted from the communication target in the first period next to the second period.

### (Supplementary Note 5)

The communication control device according to Supplementary Note 4, in which
the communication control device is configured to:
specify, in response to reception of the scanning signal, which sub-area assigned within a range of the scan area set as the communication target of a transmission source of the scanning signal the communication device is located in, and
control the transmitting device to transmit the notification signal of the pulse pattern associated with the specified sub-area toward the communication target that is a transmission source of the scanning signal.

### (Supplementary Note 6)

The communication control device according to Supplementary Note 5, in which
the communication control device is configured to:
control, in a case where it is specified that the communication device is located at a boundary between the plurality of sub-areas allocated within the range of the scan area set as the communication target of the transmission source of the scanning signal, the transmitting device to transmit the notification signal of the pulse pattern associated with a boundary between the plurality of sub-areas toward the communication target of a transmission source of the scanning signal.

### (Supplementary Note 7)

The communication control device according to Supplementary Note 5, in which
the communication control device is configured to:
control, in a case where it is determined that the communication target is located at a boundary between adjacent sub-areas, the transmitting device to widen a range of any of the sub-areas determined to have the communication target located and execute the secondary scan mode.

### (Supplementary Note 8)

The communication control device according to any one of Supplementary Notes 1 to 7, in which
the communication control device is configured to:
cause, in response to reception of the notification signal transmitted from the communication target, the transmitting device to transmit a completion notification signal for notifying reception of the notification signal toward the communication target that is a transmission source of the notification signal.

### (Supplementary Note 9)

The communication control device according to Supplementary Note 8, in which
the communication control device is configured to:
cause the transmitting device to transmit the completion notification signal having the pulse pattern different from the pulse patterns of the scanning signal and the notification signal.

### (Supplementary Note 10)

A communication device including:
a communication control device according to any one of Supplementary Notes 1 to 9:
a transmitting device that transmits a spatial optical signal under control of the communication control device; and
a receiving device that receives the spatial optical signal transmitted from a communication target, and outputs a reception signal included in the received spatial optical signal to the communication control device.

### (Supplementary Note 11)

A communication control method for controlling a transmitting device that transmits a spatial optical signal and a receiving device that receives the spatial optical signal transmitted from a communication target, the communication control method causing a computer to execute:
causing the transmitting device to transmit a scanning signal having a pulse pattern different between a first period in which the scanning signal is emitted in a forward direction and a second period in which the scanning signal is emitted in a direction opposite to the forward direction in a scan mode in which the scanning signal for searching for the communication target is transmitted;
causing the receiving device to receive the scanning signal transmitted from the communication target:
acquiring a signal relevant to the scanning signal received by the receiving device:
specifying a direction of transmission of the scanning signal by the communication target according to a reception interval between the pulse pattern of the scanning signal transmitted in the first period and the pulse pattern of the scanning signal transmitted in the second period; and
causing the transmitting device to transmit a notification signal of the pulse pattern relevant to the direction of transmission of the specified scanning signal toward the communication target.

### (Supplementary Note 12)

A non-transitory recording medium having stored therein a program for controlling a transmitting device that transmits a spatial optical signal and a receiving device that receives the spatial optical signal transmitted from a communication target,
the program causing a computer to execute:
causing the transmitting device to transmit a scanning signal having a pulse pattern different between a first period in which the scanning signal is emitted in a forward direction and a second period in which the scanning signal is emitted in a direction opposite to the forward direction in a scan mode in which the scanning signal for searching for the communication target is transmitted:
causing the receiving device to receive the scanning signal transmitted from the communication target:
acquiring a signal relevant to the scanning signal received by the receiving device:
specifying a direction of transmission of the scanning signal by the communication target according to a reception interval between the pulse pattern of the scanning signal transmitted in the first period and the pulse pattern of the scanning signal transmitted in the second period; and causing the transmitting device to transmit a notification signal of the pulse pattern relevant to the direction of transmission of the specified scanning signal toward the communication target.

### REFERENCE SIGNS LIST

1, 2 communication device
10, 20 transmitting device
11 light source
13 spatial light modulator
16, 26 receiving device
17 light receiving element
18 reception circuit
19, 29 communication control device
160 concentrator
191 condition storage unit
192 transmission condition generation unit
193 transmission control unit
195 signal acquisition unit
196 signal analysis unit
197 signal generation unit

What is claimed is:

1. A communication control device that controls a communication device including a transmitting device that transmits a spatial optical signal and a receiving device that receives the spatial optical signal transmitted from a communication target, wherein
the communication control device is that comprises a memory storing instructions, and a processor connected to the memory and configured to execute the instructions to:
cause the transmitting device to transmit a scanning signal of a pulse pattern different between a first period in which the scanning signal is emitted in a forward direction and a second period in which the scanning signal is emitted in a direction opposite to the forward direction in a scan mode in which the scanning signal for searching for a communication target is transmitted;
specify a direction of transmission of the scanning signal transmitted from the communication target according to a reception interval between the pulse pattern of the scanning signal transmitted from the communication target in the first period and the pulse pattern of the scanning signal transmitted from the communication target in the second period in response to reception of the scanning signal transmitted from the communication target by the receiving device; and
transmit a notification signal of the pulse pattern relevant to the specified direction of transmission of the scanning signal to the transmitting device toward the communication target.

2. The communication control device according to claim 1, wherein
the processor of the communication control device is configured to execute the instructions to control the transmitting device in the scan mode in such a way to repeat
a forward scanning of a scan area set in the communication device, the forward scanning being performed by sequentially moving one-dimensional scan in which the direction of transmission of the scanning signal is sequentially changed in a first direction toward a second direction orthogonal to the first direction, and
subsequent to the forward scanning, a reverse scanning of the scan area set in the communication device, the reverse scanning being performed by sequentially moving the one-dimensional scan in which the direction of transmission of the scanning signal is sequentially changed in the first direction toward a direction opposite to the second direction.

3. The communication control device according to claim 2, wherein
the processor of the communication control device is configured to execute the instructions to
control the transmitting device to transmit the scanning signal for displaying an image in which a plurality of dots are one-dimensionally arranged at regular intervals in the one-dimensional scan.

4. The communication control device according to claim 3, wherein
the processor of the communication control device is configured to execute the instructions to specify a position of the communication device in the scan area set in the communication target of a transmission source of the scanning signal according to
a first interval that is an interval between a reception timing of the pulse pattern of the scanning signal transmitted from the communication target in the first period and a reception timing of the pulse pattern of the scanning signal transmitted from the communication target in the second period next to the first period, and a second interval that is an interval between a reception timing of the pulse pattern of the scanning signal transmitted from the communication target in the second period and a reception timing of the pulse pattern of the scanning signal transmitted from the communication target in the first period next to the second period.

5. The communication control device according to claim 4, wherein
the processor of the communication control device is configured to execute the instructions to
specify, in response to reception of the scanning signal, which sub-area assigned within a range of the scan area set as the communication target of a transmission source of the scanning signal the communication device is located in, and
control the transmitting device to transmit the notification signal of the pulse pattern associated with the specified sub-area toward the communication target that is a transmission source of the scanning signal.

6. The communication control device according to claim 5, wherein
the processor of the communication control device is configured to execute the instructions to
control, in a case where it is specified that the communication device is located at a boundary between the plurality of sub-areas allocated within the range of the scan area set as the communication target of the transmission source of the scanning signal, the transmitting device to transmit the notification signal of the pulse pattern associated with a boundary between the plurality of sub-areas toward the communication target of a transmission source of the scanning signal.

7. The communication control device according to claim 5, wherein
the processor of the communication control device is configured to execute the instructions to
control, in a case where it is determined that the communication target is located at a boundary between adjacent sub-areas, the transmitting device to widen a range of any of the sub-areas determined to have the communication target located and execute the secondary scan mode.

8. The communication control device according to claim 1, wherein
the processor of the communication control device is configured to execute the instructions to
cause, in response to reception of the notification signal transmitted from the communication target, the transmitting device to transmit a completion notification signal for notifying reception of the notification signal toward the communication target that is a transmission source of the notification signal.

9. The communication control device according to claim 8, wherein
the processor of the communication control device is configured to execute the instructions to
cause the transmitting device to transmit the completion notification signal having the pulse pattern different from the pulse patterns of the scanning signal and the notification signal.

10. A communication device comprising:
a communication control device according to claim 1;
a transmitting device that transmits a spatial optical signal under control of the communication control device; and
a receiving device that receives the spatial optical signal transmitted from a communication target, and outputs a reception signal included in the received spatial optical signal to the communication control device.

11. A communication control method for controlling a transmitting device that transmits a spatial optical signal and a receiving device that receives the spatial optical signal transmitted from a communication target, the communication control method causing a computer to execute:
causing the transmitting device to transmit a scanning signal having a pulse pattern different between a first period in which the scanning signal is emitted in a forward direction and a second period in which the scanning signal is emitted in a direction opposite to the forward direction in a scan mode in which the scanning signal for searching for the communication target is transmitted;
causing the receiving device to receive the scanning signal transmitted from the communication target;
acquiring a signal relevant to the scanning signal received by the receiving device;
specifying a direction of transmission of the scanning signal by the communication target according to a reception interval between the pulse pattern of the scanning signal transmitted in the first period and the pulse pattern of the scanning signal transmitted in the second period; and
causing the transmitting device to transmit a notification signal of the pulse pattern relevant to the direction of transmission of the specified scanning signal toward the communication target.

12. A non-transitory recording medium having stored therein a program for controlling a transmitting device that transmits a spatial optical signal and a receiving device that receives the spatial optical signal transmitted from a communication target,
the program causing a computer to execute:
causing the transmitting device to transmit a scanning signal having a pulse pattern different between a first period in which the scanning signal is emitted in a forward direction and a second period in which the scanning signal is emitted in a direction opposite to the forward direction in a scan mode in which the scanning signal for searching for the communication target is transmitted;
causing the receiving device to receive the scanning signal transmitted from the communication target;
acquiring a signal relevant to the scanning signal received by the receiving device;
specifying a direction of transmission of the scanning signal by the communication target according to a reception interval between the pulse pattern of the scanning signal transmitted in the first period and the pulse pattern of the scanning signal transmitted in the second period; and
causing the transmitting device to transmit a notification signal of the pulse pattern relevant to the direction of transmission of the specified scanning signal toward the communication target.
